(19) United States
(12) Patent Application Publication
(10) Pub. No.: US 2011/0320288 A1
(43) Pub. Date: Dec. 29, 2011

(54) METHOD FOR PLAYING CONTENTS

(75) Inventors: Choong-Sup Shim, Seoul (KR); Dong-Jin Kim, Seoul (KR); Hyun-Yong Lee, Ansan-si (KR); Young-Kyu Kim, Seoul (KR); Wang-Geun Lee, Seoul (KR)

(73) Assignee: THINKPOOL CO. LTD., Seoul (KR)

(21) Appl. No.: 13/201,085

(22) PCT Filed: Feb. 12, 2010
(86) PCT No.: PCT/KR2010/000906

§ 371 Date: Aug. 11, 2011

(30) Foreign Application Priority Data
Feb. 13, 2009 (KR) 10-2009-0011937
Feb. 12, 2010 (KR) 10-2010-0013131

(51) Int. Cl. G06Q 30/00

(52) U.S. Cl. 705/14.73

(57) ABSTRACT

A method for playing contents is disclosed. The method for playing contents includes the contents providing system receiving a selection of a first contents from a device, playing at least one of a second contents before the first contents plays or while the first contents is playing, outputting information requesting user input to the device, and the first contents begins to play or resumes playing, when a user input corresponding to the information requesting user input was input.

### TECHNICAL FIELD

Example embodiments relates to methods for playing contents, and more particularly, to methods that suggest a user watching another contents or performing a pre-determined action instead of providing contents the user has chosen.

### BACKGROUND ART

With the development of communication technologies, the internet (or wireless internet) is being used to provide a user with contents services such that the users may search contents they want, choose and play the searched contents. In addition, the users, used to be customers of contents, are taking part in production and circulation of contents actively in the web 2.0 internet basis due to active user participation in the internet space.

Such the contents are being treated as undeniable transaction objects according to the type and the quality of the contents. In other words, the user needs to pay for using the contents in most cases. Cash or a predetermined mileage point is being used as ways of the payment.

On the other hand, instead of providing the contents for free, there used a method of displaying a predetermined different contents (for example, an advertisement) at the beginning or while playing the contents the user wants. At first, the user was very uncomfortable and unsatisfied with playing the different contents (for example, an advertisement), not the one they had wanted to watch. However, as the method has been widely used, the user not only is accustomed to playing the different contents (for example, an advertisement) in random, but also, is expecting to watch what the user wants without additional cost, even though there plays the different contents (for example, an advertisement) randomly.

By the way, when the different contents not the one the user wants plays randomly, most of the users do other jobs (for example, web surfing) on their devices (for example, computer) without watching the contents which is playing and even are away from their devices for other tasks during the different contents is playing, and after the different contents has finished playing, the users get back to their devices for listening or watching what they wants. Most of the users do not watch the different contents and, even if they are watching, they are not concentrated on them.

Such situations of contents using may cause problems for a main agent (for example, an advertiser), because the main agent can not achieve as what he wishes to obtain (for example, advertising effect) compared to what he has spent. The main agent has requested the contents provider (or providing system) to play the different contents (for example, advertisement) in the contents the user wants and is spending too much cost for that.

Considering it is not the times any more when contents may be provided for free, playing a certain different contents not the contents the user wants almost denotes paying the price for playing the contents the user wants. And, actually, someone (for example, an advertiser) is paying for the cost.

Thus, methods for suggesting the user watch or recognize the different contents that plays randomly are necessary, and only after the user recognizes the contents fully, it can be said that providing contents the user wants for free has an effect.

Accordingly, a technical idea that enables to compensate the price for providing the contents reasonably is necessary in providing contents to the user.

### DETAILED DESCRIPTION OF THE INVENTION

### Technical Goal of the Invention

The present inventive concept provides a method that enables to recognize at least a part of a predetermined different contents which plays as a compensation for providing contents, so that a user may use the contents he wants only after the user has watched or listened to the predetermined different contents, which means the user reasonably paid the price for playing the contents he wanted.

The present inventive concept also provides a method that suggests the user performing a predetermined action as a compensation for providing the contents, so that the user may be provided with the contents he wants only after the user performed the requested action, which means the user reasonably paid for the contents he wanted.

The present inventive concept also provides a method that estimates the value of the user action each according to the user action to be performed while playing the predetermined different contents, so that the user may pay the price for playing the contents he wants differently based on the estimated value.

The present inventive concept also provides a method that estimates the user action as a price for playing the contents the user wants, even if the different contents may not play.

The present inventive concept also provides a method that may not allow the user to use the contents he requested in a way of he wants, in case that the user has not paid reasonably for the price for playing the contents he wants.

### Effect of the Invention

According to the present inventive concept, methods for contents playing are provided that request the user to perform a predetermined action or ensure the user to recognize (watch or listen to) at least a part of predetermined different contents (contents for the compensation) that the user does not want, so that a main agent (for example, an advertiser), who wishes the different contents to play, may have an increased effect (for example, advertising effect).

For example, the advertiser may request predetermined action (for example, user input) to the user in at least a part of the contents the user wants, so that the contents the user wants may be provided to the user only after the user recognizes as much as the advertiser wishes to impress the user, which results in ensuring that the user may recognize at least a specific part or specific information of the different contents.

According to the present inventive concept, the method of estimating the value of user action performed while playing the contents the user wants or playing the different contents randomly allows the user to pay the price for playing the contents the user wants each according to the estimated value, which results in suggesting the user performing the requested action actively. In addition, new valuable information may be obtained by using the information from the user action.

According to the present inventive concept, it is possible to set the different contents to play randomly according to the content and the characteristics of the contents the user wants, which results in obtaining a targeted advertising effect.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a schematic diagram of a contents playing system configured to implement methods for playing contents according to some exemplary embodiments of the present inventive concept;

FIG. 2 is an example diagram of information requesting user input of the methods for playing contents according to some exemplary embodiments of the present inventive concept;

FIG. 3 is a diagram for explaining the process of evaluating the compensation value of the second contents by the methods for playing contents according to some exemplary embodiments of the present inventive concept;

FIG. 4 is an example diagram of providing the user with information of the compensating value;

FIG. 5 is a diagram for explaining a method for playing contents according to an exemplary embodiment of the present inventive concept; and

FIG. 6 is a diagram for explaining a method for playing contents according to an exemplary embodiment of the present inventive concept; and

FIG. 7 is an example diagram illustrating an altered contents according to an exemplary embodiment of the present inventive concept.

### BEST MODE FOR CARRYING THE INVENTION

According to an exemplary embodiment of the present inventive concept, there is provided a method for playing contents in which a contents providing system receives a selection of a first contents from a device, at least one of a second contents plays before the selected first contents plays or while the selected first contents is playing on the device, information requesting user input is output to the device while the second contents is playing or after the second contents has finished playing, and the first contents begins to play or resumes playing, when a user input corresponding to the information requesting user input was input via the device

The step of the first contents beginning to play or resuming playing includes outputting the information requesting user input while the second contents is playing, and finishing playing the second contents when the user input was input while the second contents was playing.

At least one of the number or the type of the second contents may be determined differently based on the first contents.

The method for playing contents may further include determining a compensating value according to at least one of type, content, and quantity, and determining the price for playing the first contents according to the compensating value.

At least one of the first contents and the second contents may include at least one of text information, image information, sound source information, video information, and executable application.

According to another exemplary embodiment of the present inventive concept, there is provided a method for playing contents in which a contents providing system receives a selection of a first contents from a device, at least one of second contents plays before the selected first contents plays or while the selected first contents is playing on the device, at least a part of a first region in which the first contents is playing or is to play is covered, information requesting user input is output to the device, and at least a part of the first region reveals when a user input corresponding to the information requesting user input was input via the device.

The step of revealing the covered part of the first region may include controlling the region where the second contents displays to disappear or not to overlap with the first region.

According to yet another exemplary embodiment of the present inventive concept, there is provided a method for playing contents in which a first contents plays altered in part, with a playing size equal to or not greater than a predetermined size, or covered by a predetermined image. Next step of the method includes outputting information requesting user input to a device, and then, controlling the altered part to play normally or to reveal the covered part, when a user input corresponding to the information requesting user input was input via the device.

In case that at least a part of the first contents includes image information and voice information, the method of playing altered in at least a part of the first contents may be only any one of the image information and the voice information plays, and at least one of the image information and the voice information corresponding to at least a part of the first contents plays altered, plays altered by a certain filter, plays being added by a certain noise, or plays in application of a certain image or voice effect.

The methods for playing contents may be stored to a computer decodable storage medium, which a program for implementing the methods is recoded thereon.

### MODE FOR CARRYING THE INVENTION

The attached drawings for illustrating preferred embodiments of the present invention are referred to in order to gain a sufficient understanding of the present invention, the merits thereof, and the objectives accomplished by the implementation of the present invention. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Hereinafter, the present invention will be described in detail by explaining preferred embodiments of the invention with reference to the attached drawings. Like reference numerals in the drawings denote like elements.

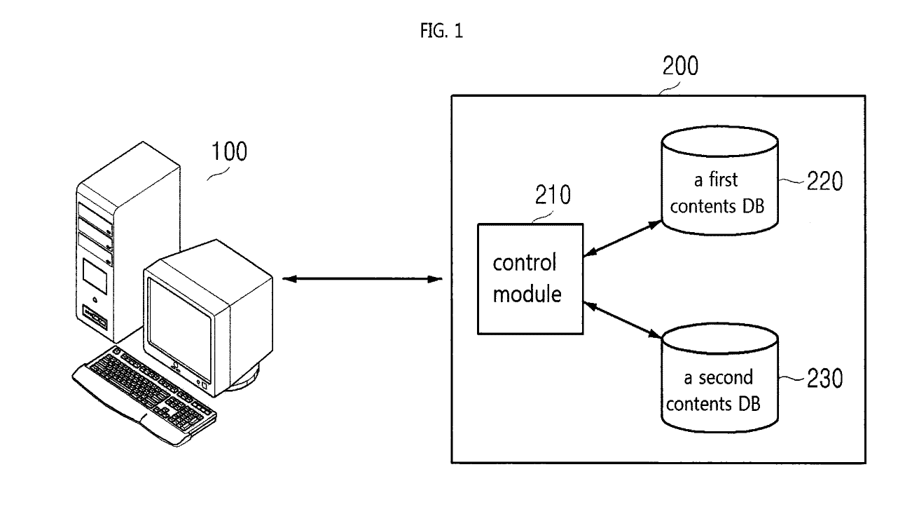

FIG. 1 is a schematic diagram of a contents providing system configured to implement methods for playing contents according to some exemplary embodiments of the present inventive concept. Referring to FIG. 1, the contents providing system 200 includes a control module 210, a first contents DB 220, and a second contents DB 230. The contents providing system 200 may transmit and receive a predetermined data to implement a device 100 and the methods for playing contents according to some exemplary embodiments of the present invention.

The contents providing system 200 may be included in a certain web server or WAP (Wireless Application Protocol) server. In some embodiments, the contents providing system 200 may be separated with the web server or WAP server and connects with the web sever or WAP server via wire/wireless communications to embody a technical idea of the present invention. And, in some embodiments, the contents providing system 200 may be installed in the device 100, or a part of the contents providing system 200 may be installed in the device 100 and the rest part may be connected with the device 100 via wire/wireless communications. The contents providing system 200 may be included in a settop box or IPTV, or may be implemented into a certain element which is connected to the settop box or IPTV.

Each element of the contents providing system 200 is illustrated separately in FIG. 1 to show each of the elements is capable of being separated in its function and logic, which does not denote being physically separated and being implemented into separate code.

A module in the present invention may denote combining hardware for carrying out a technical idea of the present invention and software for driving the hardware in function and structure. For example, it can be easily derived that the module may denote a logic unit of a certain code and a hardware resource to perform the code, and may not necessary denote a physically connected code or one type of hardware, by a person who skilled in the related art.

DB in the present invention may denote combining software and hardware to which the corresponding information is stored in function and structure. DB may be embodied as at least one table and further include separate DBMS (Database Management System) for searching, storing, and managing data stored to the DB. DB may also be embodied as forms of linked-list, Tree, relational DB, and so on, and may include all of the data storage mediums and data structures, which corresponding data can be stored thereto.

The control module 110 may control a data flow to implement the method for playing contents according to some embodiments of the present inventive concept, perform necessary operations, and control/maintain resource consume generated accordingly.

The first contents DB 220 includes contents that the contents providing system 200 is going to provide with to the device 100, that is, a first contents which was requested to be transmitted into the device 100. In other words, the first contents DB 220 includes the first contents that a user wishes to play. The contents providing system 200 may provide the device 100 with a list in respect to at least a part of the contents included in the first contents DB 220. The user may be provided with the list by the contents providing system 200, or a certain web pate and WAP (Wireless Application Protocol) page connected to the contents providing system 200. Types of the contents included in the first contents DB 220 may be various, for example, video, music, text, image, file, and a certain program designed to be performed. The meaning of playing in the present invention may be different according to the type of the contents. For instance, playing text may denote displaying test, and playing a file may denote opening the file with a predetermined program which is capable of reading the file, playing a program designed to be performed may denote performing the program, and playing music or video may denote a series of process that sound corresponding to the music is output or that sound and image corresponding to the video are output, respectively.

The second contents DB 230 includes a second contents capable of playing on the device 100 in spite that there is no request from the device 100 for compensation for playing the first contents which is stored to the first contents DB 220. That is, the second contents may denote the contents which is requested to be recognized by the user instead of playing the first contents. The second contents may include various types of contents like the first contents and the purpose for playing the second contents may be various. However, hereinafter, it would be described that the second contents is a predetermined advertising contents for the convenience of explanation, but the embodiment is not restricted thereto.

The control module 210 may perform a function of selecting the first contents and the second contents from the first contents DB 220 and/or the second contents DB 230 to embody the method for contents playing according to some exemplary embodiments of the present inventive concept. The control module 210 may control playing of the selected first contents and second contents (for example, time point of playing, stop playing, playing location, and finishing playing) and perform a function of displaying a predetermined information requesting user input on the device 100. The control module 210 may control at least a part of the first contents to be covered by the second contents or a predetermined UI (User Interface) (for example, a user interface for covering at least a part of the first contents) and at least a part of the first contents to be altered, and additional elements (for example, noise or filter) to be added to prevent at least a part of the first contents from being recognized normally. The part has not been recognized normally may be controlled to be recognized normally when the user performs a predetermined action which is requested by the contents providing system 200, so that the user may pay the price for the using the first contents he wants normally.

In addition, the control module 210 may install a predetermined code on the device 100 and communicate with the code to perform functions for embodying a technical idea of the method for playing contents according to some exemplary embodiment of the present inventive concept.

The device 100 may exchange necessary data with the contents providing system 200 and denote including all types of data processing device on which contents may play. For example, the device 100 may include computer, mobile device, and IPTV. A predetermined playing application to help at least a part of the contents received from the contents providing system 200 play may be installed in the device 100. In case of the contents providing system 200 providing a web page and/or a WAP page, the playing application may include a web client for receiving and playing contents by accessing the web page and/or WAP page. The web client may be a form of web browser or video player capable of communicating with the contents providing system 200. The playing application may be installed in TV or IPTV, in case that the device 100 is implemented into TV or IPTV.

The contents providing system 200 may receive a contents selecting signal from the device 100. When the user chooses contents information displayed on the device 100, the contents selecting signal is transmitted from the device to the contents providing system 200. When the device 100 accesses a web server or a WAP server, the user may choose at least one contents information among contents information displayed on the web page or WAP page provided by the web server or WAP server. When the device is implemented into TV or IPTV, contents information may be displayed on a predetermined UI (User Interface) provided by the device 100, and the user may choose at least one contents information displayed.

The contents information may include information (for example, URL and identification number) capable of identifying the first contents stored to the contents providing system 200. Then, the contents providing system 200 may provide the first contents corresponding to the contents selecting signal received from the contents providing system 200.

At this time, the contents providing system 200 may control the second contents to play on the device 100 before the first contents plays on the device 100. For that, the contents providing system 200 transmits the second contents to the device 100 before providing the first contents. In some embodiments, the first contents may be transmitted in advance of the second contents. But, regardless of the transmitting order, it can be controlled, so that the second contents may play before the first contents play. In case that the contents providing system 200 is installed in the device 100, it can be controlled, so that the first contents or the second contents may play in a fixed order without a separate transmitting process.

Transmitting contents of the contents providing system 200 may include transmitting data corresponding to the contents in a manner of downloading and/or streaming. Then, the device 100 plays the first contents after playing at least one of the second contents has finished.

According to an exemplary embodiment of the present inventive concept, the first contents plays on the device 100 first and at least one of the second contents plays while the first contents is playing. Then, the first contents may resume playing after playing at least one of the second contents has finished.

At this time, according to one of the main technical ideas of the present invention, while the second contents (for example, advertisement) is playing, the second contents stops playing and information requesting user input is output, and thereafter, when a user input corresponding to the information requesting user input is input, the stopped second contents continues to play. The outputting the information requesting user input may denote displaying the information requesting user input in forms of text, image, video, or playing predetermined voice information on the device 100.

That the second contents stops playing and information requesting user input is output do not represent the time order. In other words, a time when the second contents stops playing and when the information requesting user input is output may be identical, but it is not restricted thereto, for instance, playing the second contents may stop after displaying the information requesting user input, or after playing the second contents stops, the information requesting user input may be requested.

Thus, unless the user performs action corresponding to the action requested by the contents providing system 200 (that is, user input), the second contents may not stop playing. Therefore, only when the user performs the action requested by the contents providing system 200 (that is, user input), the first contents begins to play or continues to play from the stop point.

As a result, the user may not choose the way of having not watched or listened to the second contents while the second contents is playing and thereafter watching or listening to the first contents when the first contents begins to play with the method according to an exemplary embodiment of the present invention. Therefore, the method for playing contents ensures the effect that a main agent providing the second contents wishes to obtain in some parts. The main agent providing the second contents may denote the main agent (for example, advertiser) who has requested the second contents to be provided via the contents providing system 200, not the main operating body of the contents providing system 200.

According to an exemplary embodiment of the present inventive concept, the information requesting user input is output while the second contents is playing, but the second contents may not stop playing. In other words, unlike the above described exemplary embodiment, the second contents may play continuously without stopping, and when the user fails to perform the requested actions, it can be controlled, so that the first contents may not begin to play or resume playing before playing the second contents has finished and even after playing the second contents has finished.

Also, the time when the information requesting user input is output, it is not necessary while the second contents is playing, and the information may be output after all the second contents has finished playing. At this time, the information requesting user input may be information or action that can be obtained when the user has watched or recognized the content that is included in the second contents or that the second contents plays. Thus, the user may perform the action corresponding to the information requesting user input only after he has watched or recognized the second contents. If the user fails to watch or recognize the second contents, the user can not perform the action corresponding to the information requesting user input, which results in that the first contents may not begin to play. If the second contents begins to play while the first contents is playing, the rest part of the first contents which was expected to continue to play after playing the second contents may not play. Therefore, according to the technical idea of the present invention, only after the user watched or recognized the second contents, that is, the user paid the price for playing the first contents, the first contents is provided to the user.

In some embodiments, in cases that the second contents has not stop playing, the information requesting user input was displayed, and the user performed the action corresponding to the information requesting user input, but still the second contents is playing, the contents providing system 200 may quit playing the second contents. Because it can be regarded that the user paid the price enough for playing the first contents by performing the action corresponding to the information requesting user input, even if the user has not watched or recognized all the second contents, the user may quit playing the second contents and begin to play or resume playing the first contents.

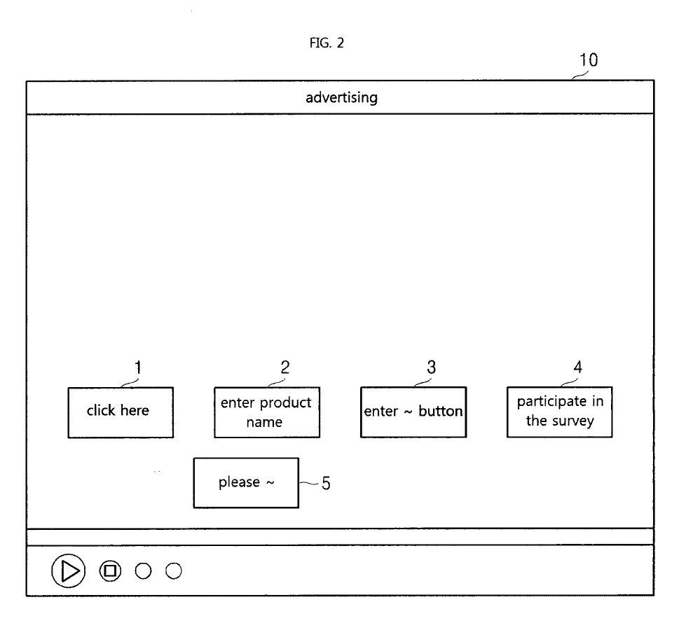

The user input may be various types of selecting an input interface (for example, key on the keyboard, button on the mouse, and touch screen interface) equipped by a user input apparatus (for example, keyboard, mouse, key pad, joy stick, remote controller, and touch screen) of the device 100, selecting the point where the information requesting user input to be displayed (for example, click), or inputting predetermined text information. When the device 100 is a computer, an example of the information requesting user input is illustrated in FIG. 2.

FIG. 2 is a diagram explaining an example of information requesting user input of the method for playing contents according to some exemplary embodiments of the present inventive concept. Referring to FIG. 2, at least one of the information requesting user input 1˜5 as shown in FIG. 2 is displayed while the second contents is playing through predetermined playing application 10 installed in the device 100. The playing application 10 may be the application that has been transmitted from the contents providing system 200 to the device 100 and installed in the device 100 or that was already installed in the device 100, as described above.

The first information requesting user input 1 may be a UI (User Interface) requesting the user to choose the first information requesting user input 1 by using an input device (for example, mouse) capable of pointing the location. In some cases that the device 100 is a computer or mobile device equipped with touch screen, the user is requested to touch on the part corresponding to the information requesting user input 1.

The second information requesting user input 2 may be a UI (User Interface) requesting the user to input a predetermined content (for example, title of the product) included in the second contents (for example, advertisement). When using the second information requesting user input 2, the main agent providing the second contents may obtain an effect of impressing the user with the title of the product that he would like to advertise.

The third information requesting user input 3 may be a UI (User Interface) requesting the user to input a specific key or button on an input device (for example, keyboard, and key pad of mobile device), for example, “please press the enter key”, “please press the space bar”, and “please insert the number 0”.

The fourth information requesting user input 4 may be a UI (User Interface) requesting the user to participate in the survey. The survey may be related to the second contents (for example, impression on the advertisement and comments on the products after using the product), or not be related to the second contents. Performing the action by the fourth information requesting user input 4, that is, answering the survey, may request relatively large user inputs. For this, the method for playing contents according to an exemplary embodiment of the present invention provides a technical idea to compensate the large amount of inputs properly, which will be described later.

The fifth information requesting user input 5 may be a UI (User Interface) that enables to determine whether the user has performed corresponding actions by using an input device equipped by the device 100 even different from the above description or a separate sensing apparatus (for example, way of voice recognition, way of gesture recognition, and camera).

Referring to FIG. 1 again, the method for playing contents according to some exemplary embodiments of the present invention provides a technical idea that the second contents to be provided to the device 100 is determined based on the first contents which is already chosen by the user.

For this, each of the second contents stored to the contents providing system 200 is set to correspond to the first contents stored in the first contents DB 220 in advance. For instance, the second contents and information in respect to the corresponding first contents may be stored in the second contents DB 230. Accordingly, when the first contents is chosen, the second contents corresponding to the first contents is determined automatically, and the determined second contents is provided to the device 100.

As a result, the main agent providing the second contents (for example, an advertiser) may select the first contents which is expected to have a high effect when the corresponding second contents is provided to the user, which denotes target advertisement is possible.

In addition, the main agent providing the second contents or the contents providing system 200 may determine the time point when the second contents would stop while the second contents is playing, which results in getting the maximum effect (for example, advertising effect). For instance, when the second contents is an advertising video, the advertiser providing the second contents may wish to impress the user with a specific scene, for example, a scene showing a product title or an effect of the product. When the second contents is a music file, the advertiser wishes the music to stop at a specific point, because most of the user may recognize the music being resumed after having been stopped. To control the predetermined stop point like described above, stop information representing the predetermined stop point may be stored to the contents providing system 200 in advance. Or, the contents providing system 200 may include a predetermined tag or flag information which represents the stop point in the second contents. Thus, the playing application installed in the device 100 may play the second contents, and may stop playing the second contents when the tag or flag information is recognized.

The stop information stored to the contents providing system 200 may include at least one of playing time information or the content of the second contents. For example, the contents providing system 200 may include information in respect to the stop point of the whole playing time of the second contents. Accordingly, the contents providing system 200 may control the playing application 10 installed in the device 100 based on the information in respect to the stop point. For example, when the second contents is a 30 seconds long video, if it was scheduled to stop playing the second contents at 10 seconds after playing, the contents providing system 200 stores the information in respect to the second contents and the stop information of the second contents.

Controlling the stop point according to information in respect to the content of the second contents may denote stopping playing the second contents, when the image or the sound source in which preset information is included is recognized by analysing the second contents at a real time. For this, the control module 210 of the contents providing system 200 may include an image recognition module (not shown) or a voice recognition module (not shown) based on the type of the contents. For instance, when the advertiser of the second contents wishes to stop playing at all the moments of showing the advertising product, the contents providing system 200 stores image information corresponding to the product as stop information, and thereafter, when the image information corresponding to the product is recognized while the second contents is playing, transmits a predetermined control signal (for example, frame information corresponding to the image) to the device 100, so that playing the second contents stops where the corresponding image is shown. In some embodiments, when the contents providing system 200 transmits such the stop information that has been stored thereto to the device 100, the device 100 may perform image recognition or voice recognition according to the type of the contents.

As a result, the method for playing contents according to an exemplary embodiment of the present invention may control the stop point, so that the main agent providing the second contents (for example, advertiser) may control to stop playing of the contents at the scene or point where he wants to stop, which results in maximizing the effect that he wishes to obtain.

Meanwhile, the first contents has a concept of enabling to trade according in the method for playing contents according to some exemplary embodiments of the present invention. And, watching or listening to the second contents itself is regarded as a concept of the price the user paying. In addition to that, the user action that is requested by the contents providing system 200 is also regarded as the price the user paying. Thus, since the first contents may have different value with each other, the price the user needs to pay, in other words, the type, the playing time, and the number of the second contents may be different. In addition, the price value may be evaluated differently according to the user action. For example, when the first contents is high priced, the number of the second contents to play may be the plural, or the contents whose playing time is long is selected as the second contents. When the first contents is low priced, a single second contents plays, or the contents whose playing time is relatively short is selected as the second contents. The type of the second contents may be classified in advance, and the second contents is to play may be different according to the type. For example, the advertising cost may have been set per each of the second contents, and the second contents may be classified in advance according to the advertising cost. Accordingly, the second contents plays may be different based on the advertising cost classification. The second contents may be classified based on the content (for example, financial instrument, general goods, and public service), and the second contents is to play may be different according to the content. For example, the second contents may be selected based on the demanders of the first contents, and the second contents selected at this time may have the content that draws the demander's interest. Accordingly, in case that the second contents is an advertising contents, it is effective to advertise the second contents to the demanders of the first contents.

For the above, information in respect to the compensating value according to the content, playing time of the second contents, and so on may be stored in the second contents DB 230 of the contents providing system in advance. For example, the compensating value of a certain second contents may be 10 p and another may be 20 p. The contents providing system 200 may appraise the income from the main agent providing the second contents differently per such the compensating value.

Information in respect to the playing price of each first contents may also be stored in the first contents DB 220. For example, a certain first contents may be 10 p and another may be 50 p.

Then, the contents providing system 200 may determine the type and/or the number of the second contents differently or request different user input according to the price of the first contents selected by the user. For example, if the price for playing the first contents is 30 p, the contents providing system 200 selects at least one of the second contents such that the sum of the compensating value would be 30 p. Or, the information requesting user input can be set such that user actions corresponding to the information requesting user input would be 30 p. For example, three second contents whose compensating value is each 10 p may be selected and a single second contents whose compensating value is 30 p may be selected. Or, the information requesting user input may be set such that a user input of 30 p value is performed.

In some embodiments, the method for playing contents may allow the user to select the sum of the compensating value according to the second contents.

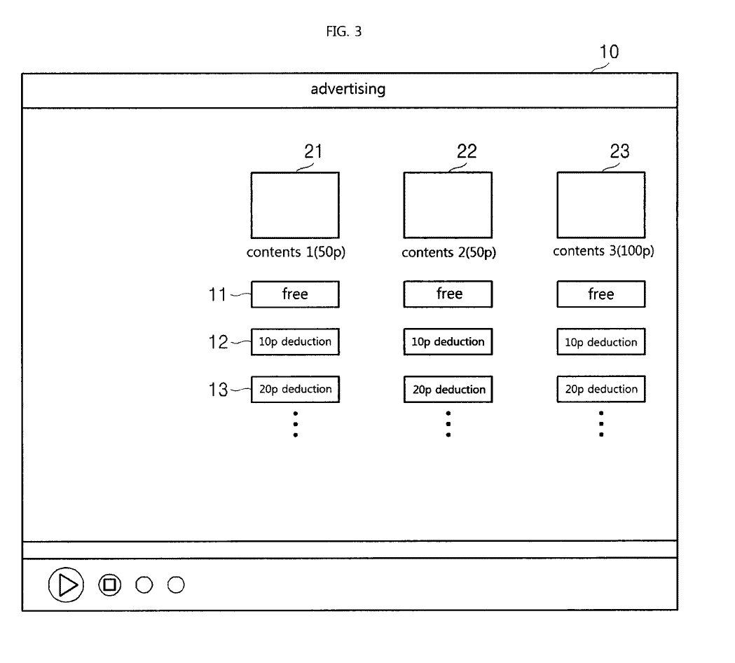

FIG. 3 is a diagram for explaining the process of evaluating the compensating value according to the second contents. Referring to FIG. 3, predetermined lists 21˜23 of the first contents may be displayed on a playing application installed in the device 100. The user may select any one of the lists 21˜23. Then, predetermined deduction interface 11˜13 may be displayed on the playing application.

For example, when the user chooses the contents 1 (21), the deduction interface 11˜13 as shown in FIG. 3 may be displayed. Thereafter, when the user chooses the first deduction interface 11, the contents providing system 200 may select at least one of the second contents, so that the sum of the compensating value of the second contents may be equal to or greater than the price for playing the contents 1 (50 p). In case that there are various combinations of the second contents, the contents providing system 200 selects the second contents in a random way or in a priority order which has been set according to a predetermined rule. For example, when the user chooses the second deduction interface 12, the contents providing system 200 may select at least one of the second contents, so that the sum of the compensating value would be 10 p. And, when the user chooses the third deduction interface 13, the contents providing system 200 may select at least one of the second contents, so that the sum of the compensating value would be 20 p.

In case that the user chooses the second deduction interface 12 or the third deduction interface 13, the user may pay the difference between the price for playing the contents 1 (50 p) and the sum of the compensating values (10 p or 20 p) in cash or mileage. In some embodiments, the difference may be covered by a user action.

According to the technical idea of the present invention, the user action (that is, user input) may also be regarded as the price for providing with the contents. Thus, the compensating value may be different according to the user action or the result of the user action.

The compensating value of the user input may be determined according to at least one of type, content, and quantity of the user input. When the compensating value is determined according to the type of the user input, the type of the user input may include user actions classified by an input device (for example, keyboard, mouse, and touch screen) and/or classified by user actions through the input device (for example, choosing a certain key through a keyboard, choosing a certain button or location through a mouse, and choosing a certain location through touch screen). Thus, it is possible to apply the different compensating values according to the type of the user input. In case of the simplest user input (for example, enter key input and a certain button input), there might be no compensating value thereon. If the user inputs specific information, much higher the compensating value would be evaluated.

Such the compensating value may be determined differently according to the content of the user input, that is, the quality of the user input. The quality of the user input may be evaluated by service administrator after the fact or according to the input item or information (for example, personal information such as contact number of the user, gender, age, and job) automatically. In some cases, the information requesting user input may have a required item and a recommended item, and if there happen a user input corresponding to the recommended item, much higher the compensating value would be evaluated. Of cause, when there is no user input corresponding to the required item, the first contents may not be used normally.

And, the compensating value may be determined differently according to the quantity of the user input. When simple text information such as a title of the advertising product is input, a small point may be regarded as the compensating value according to the user input. In survey, a large point may be regarded as the compensating value.

As described above, the user input may have the compensating value based on various ways and standards. Therefore, the compensating value deducted by choosing the deduction interfaces 11˜13 shown in FIG. 3 may be the sum of the compensating values according to the content or the number of the second contents, and/or user actions.

As a result, the price for playing the first contents may be determined by a difference between the predetermined price for playing the first contents and the compensating value, wherein, the compensating value is evaluated by the second contents itself, only by the user action, and by both the second contents itself and the user action.

In some embodiments, the compensating value may be higher than the price for playing the first contents. Because the main agent providing the second contents sometimes wishes to obtain much more detailed information and a large quantity of information, even if he should cost much. At this time, it can be evaluated that the user action is much valuable than the price for playing the first contents. In this case, a predetermined point may be saved to the user by the difference, and the saved point may be used when being provided with the first contents next time. Of cause, cash may be provided to the user instead of saving point in some embodiment.

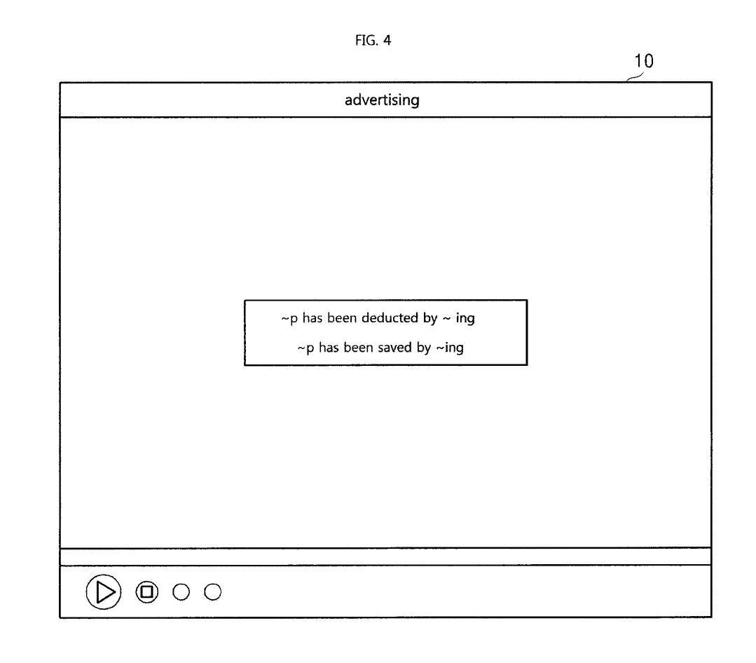

FIG. 4 is an exemplary image showing information in respect to the compensating value. Referring to FIG. 4, as described above, the contents providing system 200 evaluates the compensating value each according to the second contents itself and/or the user input(action), and a result of the evaluation is informed to the user as shown in FIG. 4. It may happen when the user chooses the compensating value which is to be deducted as in FIG. 3, but it may also happen that the contents providing system 200 chooses the second contents or the user input randomly, thus, it is necessary to provide the user with the information in respect to the compensating value, so that the user may be informed that playing the second contents and/or requesting the user action may be regarded as the fair price, which results in having an effect of removing adverse feeling to the second contents playing and the user action.

According to an embodiment of the present inventive concept, a method is provided that the user pays the fair price by performing the user action while only the first contents the user selected is playing, unlike described above.

For example, the first contents stops playing while the first contents is playing on the device 100, and the information requesting user input may be displayed. When the user input corresponding to the displayed information requesting user input was input, the stopped first contents may resume playing.

It is as described in the former embodiments that the compensating value may be determined according to the user input, accordingly, the price for playing the first contents that the user may actually pay may be determined.

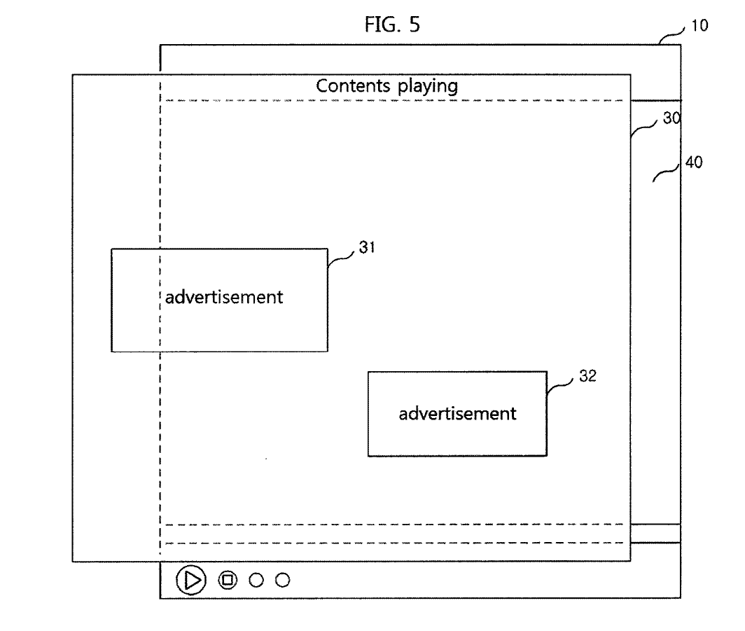

FIG. 5 is a diagram for illustrating contents playing by the methods according to an exemplary embodiment of the present inventive concept. Referring to FIG. 5, the method for playing contents includes covering at least a part of a region 40 where the first contents plays in the playing application 10 by a predetermined second contents (for example, 30,31,32). The content and the number of the second contents 30,31,32 may be determined differently according to the compensating value or the content of the first contents, as described above.

As shown in FIG. 5, the contents providing system 200 may control the second contents 30,31,32 to cover at least a part of the region 40 where the first contents is playing and output predetermined information requesting user input during and/or after the second contents play. When the user perform a predetermined action corresponding to the information requesting user input, the region 40 is not covered by the second contents any more. This is achieved by removing the region where the second contents plays by finishing playing the second contents or by playing the second contents in a region which is not overlapped with the region 40, while the second contents continues playing. When the user input corresponding to the information requesting user input is not performed, at least a part of the region 40 is covered by the second contents which has finished playing, such that the user may not be provided with the first contents normally.

When the user pay the fair compensation, the user may use the first contents he wants without any covered part.

The second contents may play before and/or while the first contents is playing. When the user action corresponding to the information requesting user input is input, the contents providing system 200 may control at least a part of the region 40 not to be covered after the second contents has finished and even in the case that the second contents has not finished playing.

According to an exemplary embodiment of the present inventive concept, the region 40 may be covered by the second contents, but the region 40 may be covered in at least a part thereof by a predetermined UI (User Interface) (for example, a figure such as rectangular or circle) not by a certain contents. At this time, since it is not possible to provide the user with information that the provider of the second contents wishes to obtain, requesting a user action for the compensation is preferable. For example, after covering at least a part of the first contents with a simple rectangular figure, the user may be suggested to input the user's interest through information requesting user input or perform a specific action after watching a specific advertisement. In other words, the user may pay the price for providing the first contents by performing the action corresponding to the information requesting user action. And as described above, the compensating value of such the action may be evaluated in a predetermined way, and in case that the compensating value is lower than the price for providing the first contents, the user may be requested to pay the additional cost, and in opposite case, the user may be provided with a predetermined compensation (cash or point).

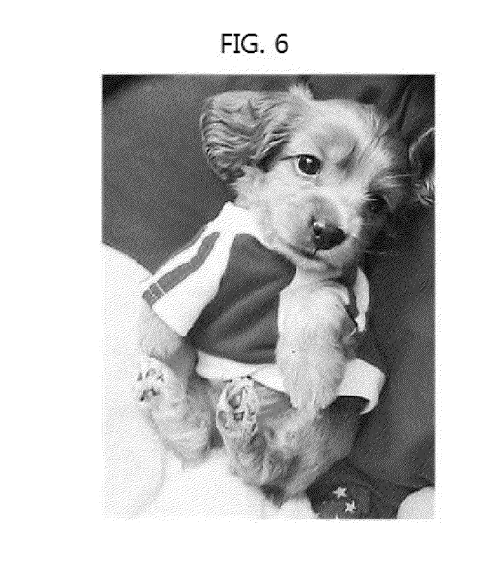

FIG. 6 is a diagram for explaining a method for playing contents according to an exemplary embodiment of the present inventive concept. First of all, referring to FIG. 6, the contents shown in FIG. 6 may be the first contents the user wants to play. The first contents may be a text and/or a video, which is as described above.

Then, the contents providing system 200 may control the first contents to alter at least in a part and to play, or may control the playing image size of the first contents to be equal to or not greater than a predetermined size.

For example, when the first contents is an image or a video contents, the first contents may be displayed below a predetermined size, such that the user may have a difficulty of recognizing and the user may not enlarge the playing size. Only after the user pays the fair price, the user may enlarge the play size or set the playing size at his discretion.

And, when the first contents is a voice contents, a certain part of the voice contents may alter not to make any sound or may alter the property of sound (for example, pitch, volume, and tone). There might be other ways to prevent the user from using at least a part of the first contents normally such as adding a certain noise to the part and removing a specific element of sound (for example, frequency or amplitude) by using a predetermined filter.

When the first contents is an image contents, the image property (for example, color, brightness, chroma, and resolution) of at least a part of the first contents may alter, or, a specific part of the image information may not displayed by using a predetermined filter, adding a noise, and applying mosaic or blurring, so that the user may not use at least a part of the first contents normally.

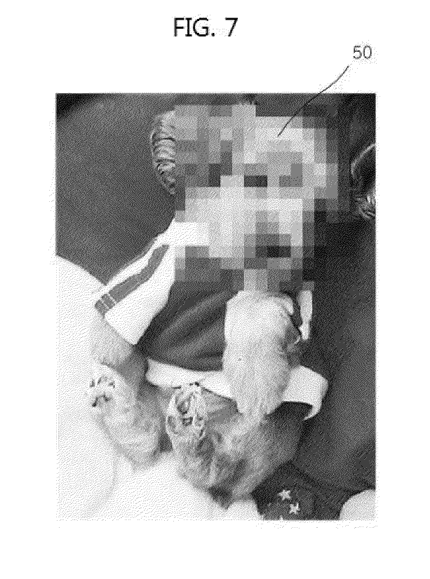

An example of the above is illustrated in FIG. 7. FIG. 7 illustrates mosaic filter or mosaic effect is applied to a part 50 of the first contents of FIG. 6. Like this, the contents providing system 200 may request the user to pay the fair price by preventing the user from using at least a part 50 of the first contents normally. The requesting the compensation may be performed through the information requesting user input described above, and the paying the compensation may be performed by taking action corresponding to the information requesting user input.

Predetermined information requesting user input may be shown as in FIG. 2 before and/or during playing the altered contents as shown in FIG. 7 on the device 100. If the user performs action corresponding to the information requesting user input, the contents providing system 200 may control to play the original contents before altering, that is, the contents as shown in FIG. 6. If not, the altered contents as shown in FIG. 7 continues to pay, or no contents may play.

The contents providing system 200 may store information in respect to the original contents and the altered contents in advance, or may choose a specific effect or filter in real time, so that the altered contents may play on the device 100. Thereafter, if a fair user action is performed, the originally stored contents may play (or resume playing) or the contents alteration by a specific effect or a specific filter may not occur.

For example, when the first contents is a video, any one of the image or the voice may play, such that the user fails to use or consume at least a part of the first contents normally, unless the user pay the fair compensation. When the fair compensation is paid, both of the image and the voice resume playing, so that the user may use the contents normally.

The methods for playing contents according to exemplary embodiments of the present inventive concept may be implemented in computer-readable code stored on a computer readable storage medium. A computer-readable storage medium may include all kinds of storage device capable of storing data which may be accessed by a computer system. Examples of computer readable recording medium are ROM, RAM, CD-ROM, magnet tape, hard disk, floppy disk, and optical data storage device, and any other medium that can be implemented in the form of carrier wave may be included. And functional program, code and code segments to implement the present invention may be derived easily by a person who skilled in the art.

While the present invention has been particularly shown and described with reference to exemplary embodiments thereof, it will be understood that various changes in form and details may be made therein without departing from the spirit and scope of the following claims.

### INDUSTRIAL APPLICABILITY

Methods for playing contents according to the present inventive concept may be used when playing contents on internet web pages, wireless web pages, IPTV, and so on.

1. A method that a first contents corresponding to a contents selecting signal received from a device is provided to the device by a contents providing system, the method comprising:
playing at least one of a second contents before playing the first contents on the device; and
playing the first contents after playing the second contents has finished,
wherein the playing the second contents comprising:
stopping playing the second contents while the second contents is playing and outputting information requesting user input, and
resuming playing the second contents when a user input corresponding to the information requesting user input was input.

2. A method that a first contents corresponding to a contents selecting signal received from a device is provided to the device by a contents providing system, the method comprising:
playing at least one of a second contents while the first contents is playing on the device; and
resuming playing the first contents after playing the second contents has finished,
wherein the playing the second contents comprising:
stopping playing the second contents while the second contents is playing and outputting information requesting user input; and
resuming playing the second contents when a user input corresponding to the information requesting user input was input.

3. The method of claim 1, wherein the second contents is any one of selected contents among at least one of predetermined contents which was determined to correspond to the first contents in advance.

4. The method of claim 1, wherein a time point when the second contents stops playing is determined based on stop information stored to the contents providing system in advance or predetermined tag information which is included in the second contents.

5. The method of claim 4, wherein the stop information includes at least one of information in regard to playing time of the second contents and content of at least a part of the second contents.

6. The method of claim 1, wherein at least one of the number and the content of the second contents is determined based on the first contents.

7. The method of claim 1 further comprises determining a compensating value according to at least one of type, content, and quantity of the user input.

8. The method of claim 1 further comprises determining a compensating value according to the second contents.

9. The method of claim 1, wherein at least one of the first contents and the second contents comprises at least one of text information, image information, sound source information, video information, and executable application.

10. The method of claim 1, wherein the user input includes choosing a predetermined interface installed in an input device, choosing the location where the information requesting user input to be displayed by using the input device, or inputting predetermined text information.

11. The method of claim 1, wherein the second contents is a predetermined advertising contents.

12. A method that a first contents corresponding to a contents selecting signal received from a device is provided to the device by a contents providing system, the method comprising:
stopping playing the first contents while the first contents is playing and outputting information requesting user input; and
resuming playing the first contents when a user input corresponding to the information requesting user input was input.

13. The method of claim 12 further comprises determining a compensating value according to at least one of type, content, and quantity of the user input.

14. A method that a first contents corresponding to a contents selecting signal received from a device is provided to the device by a contents providing system, the method comprising:
playing at least one of a second contents before the first contents plays or while the first contents is playing on the device; and
beginning or resuming playing the first contents after playing the second contents has finished,
wherein the method further comprises outputting information requesting user input; and
wherein the beginning or resuming playing the first contents includes beginning or resuming playing the first contents when a user input corresponding to the output information requesting user input was input and playing the second contents has finished.

15. A method for playing contents comprising:
a contents providing system receiving a selection of a first contents through a device;
playing at least one of a second contents before the first contents plays or while the first contents is playing on the device;
outputting information requesting user input to the device while the second contents is playing or after playing the second contents; and
beginning or resuming playing the first contents when a user input corresponding to the information requesting user input was input.

16. The method of claim 15, wherein the beginning or resuming playing the first contents includes finishing playing the second contents, when the information requesting user input is output, and thereafter the user input is input, while the second contents is playing.

17. A method for playing contents comprising:
a contents providing system receiving a selection of a first contents through a device;
playing at least one of a second contents before the first contents plays or while the first contents is playing on the device and covering at least a part of a first region where the first contents is playing or is to play by the second contents;
outputting information requesting user input to the device; and
revealing the covered part of the first region, when a user input corresponding to the information requesting user input was input by the device.

18. The method of claim 17, wherein the revealing the covered region includes controlling a region where the second contents is displayed to be exposed or not to be overlapped with the first region, wherein the second contents is playing or has finished playing.

19. A method for playing contents comprising:
playing the first contents with at least a part of the first contents altered, with a playing size equal to or not greater than a predetermined size, or with covered by a predetermined image;
a contents providing system outputting information requesting user input; and
the altered part getting back to original or revealing covered part, when a user input corresponding to the information requesting user input was input by the device.

20. The method of claim 19, wherein playing the first contents with at least a part of the first contents altered includes playing only any one of image information and voice information, playing the first contents with at least one of the image information and the voice information altered in its property, altered by a filter, being added a noise, or being applied an image effect or voice effect, when at least a part of the first contents includes image information and voice information.

21. A computer decodable storage media, which a program for performing the method of claim 1.

22. The method of claim 2, wherein the second contents is any one of selected contents among at least one of predetermined contents which was determined to correspond to the first contents in advance.

23. The method of claim 2, wherein a time point when the second contents stops playing is determined based on stop information stored to the contents providing system in advance or predetermined tag information which is included in the second contents.

24. The method of claim 2 further comprises determining a compensating value according to at least one of type, content, and quantity of the user input.

25. The method of claim 2 further comprises determining a compensating value according to the second contents.
